(19) United States
(12) Patent Application Publication
(10) Pub. No.: US 2026/0139767 A1
(43) Pub. Date: May 21, 2026

(54) BIOMIMETIC WATER STORAGE AND TRANSPORT SYSTEM ADAPTED FOR LOW OR ZERO GRAVITY ENVIRONMENTS

(71) Applicant: New Mexico Tech University Research Park Corporation, Socorro, NM (US)

(72) Inventor: Ashok K. Ghosh, Socorro, NM (US)

(21) Appl. No.: 19/393,304

(22) Filed: Nov. 18, 2025

Related U.S. Application Data
(60) Provisional application No. 63/722,337, filed on Nov. 19, 2024.

(51) Int. Cl. F16L 9/12; B33Y 10/00; B33Y 80/00; F16L 9/19

(52) U.S. Cl. CPC F16L 9/12; B33Y 10/00; B33Y 80/00; F16L 9/19

(57) ABSTRACT

The present disclosure relates a water storage and transport system, particularly useful for use in low and zero gravity environments, that can be integrated into a shielding or other external structures.

### CROSS-REFERENCE

This application claims priority to U.S. Provisional Patent Application No. 63/722,337, filed on Nov. 19, 2024, the contents of which are incorporated herein by reference in their entirety.

### BACKGROUND

The present disclosure relates a water storage and transport system, particularly well-suited for water-transport in low or zero gravity environments. Historically, water and storage transport systems include one or more mechanical pumps and one or more storage tanks. These components occupy volume and have a substantial weight. These factors of volume and weight may be critical in certain applications, such as in a spacecraft. The present disclosure describes a water storage and transport system that avoids the need for mechanical pumps and storage tanks.

The present disclosure also offers a solution to various problems associated with space exploration. In addition to issues with mass and volume constraints, the system disclosed herein has advantageous benefits associated with resource efficiency, system complexity, maintenance requirements and power conservation.

### SUMMARY

The present disclosure describes a water-transport system comprising: a plurality of vertically-oriented tubules comprising a lightweight polymer with a plurality of vertically-oriented tubules, wherein each tubule comprises a cylindrical wall containing a plurality of pores.

Preferably, the lightweight polymer comprises polyetheretherketone, and more preferably, NASA-qualified polyetheretherketone. The cylindrical wall of the tubule may have a diameter ranging from about 100 microns to about 150 microns. Each tubule of the plurality of tubules may be located greater than 50 microns away from another tubule of the plurality of tubules and/or no greater than 400 microns away from another tubule of the plurality of tubules. The cylindrical wall may further comprise one or more horizontally-oriented interconnecting nodes so that at least one of the tubules is in fluid communication with an adjacent tubule.

Each pore of the water-transport system may have a diameter ranging from about 10 microns to about 400 microns. The plurality of pores located at the upper end of the tubule may have a greater diameter than pores located at the bottom end of the tubule. Each pore has an internal surface facing the water passageway within the tubule. The internal surface of the pore may be treated to achieve a mean roughness ranging from about 5 to about 10 microns. Each pore may have a contact angle ranging from of 20° to 60°. The combination of the tubules, pores, and interconnecting nodes form a void in the lightweight polymer that is designed to house and transport water.

The present disclosure also describes a composition comprising the water-transport system as a layer in the composition and at least one additional layer. Preferably, the composition comprises a layer comprising the water-transport system; a structural layer; a fire resistance layer; a radiation shielding layer; and a Micrometeoroids and Orbital Debris (MMOD) layer. One or more layers of the composition may be 3D printed. Preferably, the layer comprising the water-transport system; the structural layer; the fire resistance layer; the radiation shielding layer; and the MMOD layer are all 3D printed. The fire resistance layer may disposed in between the structural layer and the layer comprising the water-transport system. The structural layer and/or the MMOD layer are preferably the exterior layers of the multi-layer composition. The radiation shielding layer may be disposed in between the MMOD layer and the layer comprising the water-transport system. The layer comprising the water-transport system may comprise polyetheretherketone, preferably NASA-qualified polyetheretherketone. The structural layer may comprise Aerospace grade aluminum 7075-T6, Carbon fiber reinforced PEEK, and/or titanium. The fire resistance layer may comprise poly-para-phenylene polytetrafluoroethylene, silica fiber woven fabric with PTFE coating, and/or terephthalamide. The radiation shielding layer may comprise polyethylene. The MMOD layer may comprise polyetheretherketone. The radiation shielding layer may further comprise an ionic liquid, preferably a mixture of 1-butyl-3-methylimidazolium tetrafluoroborate and water. The MMOD layer may further comprise an ionic liquid, preferably Trihexyl(tetradecyl)phosphonium bis(trifluoromethylsulfonyl)imide.

The present disclosure also describes a method of making a composition comprising printing the structural layer; allowing the structural layer to cool; on the structural layer, printing the fire resistance layer; on the fire resistance layer, printing the layer comprising a water-transport system; on the layer comprising a water-transport system, printing the radiation shielding layer; on the radiation shielding layer, printing the MMOD layer; and obtaining the composition.

### BRIEF DESCRIPTION OF THE DRAWINGS

FIG. 1 depicts a perspective view of an exemplary composition comprising a water-transport system and a plurality of other layers.

FIG. 2 depicts a cross-section of an exemplary tubule-containing layer, such as the water-transport layer, the MMOD layer, and/or radiation shielding layer, with homogenous tubule diameters dispersed in a non-uniform manner.

FIG. 3 depicts a cross-section of an exemplary tubule-containing layer with homogeneous tubule diameters dispersed in a uniform manner.

FIG. 4 depicts a cross-section of an exemplary tubule-containing layer with heterogenous tubule diameters dispersed in a non-uniform manner.

FIG. 5 depicts the cross-section of FIG. 4 and further depicts a plurality of sensors.

FIG. 6 depicts a cross-section perspective view in a plane intersecting the center of two adjacent tubules of a tubule-containing layer.

### DETAILED DESCRIPTION

This description is not provided to limit the disclosure to the embodiments described herein, but rather to explain and teach various principles to enable one of ordinary skill in the art to understand these principles and, with that understanding, be able to apply them to practice not only the embodiments described herein, but also other embodiments that may come to mind in accordance with these principles. The scope of the instant disclosure is intended to cover all such embodiments that may fall within the scope of the appended claims, either literally or under the doctrine of equivalents. All references cited in the present disclosure are incorporated by reference in their entirety.

### Definitions

The following terms or definitions are provided solely to aid in the understanding of the present disclosure. Unless specifically defined herein, all terms used herein have the same meaning as would be understood to one of ordinary skill in the art.

As used herein, the singular forms “a”, “an”, and “the” include both singular and plural unless the context clearly indicates otherwise.

As used herein, the term “about” should be construed as encompassing a range of ±10% of the provided numerical value. Thus, “about 10” in the context of this disclosure is inclusive of 9 to 11.

As used herein, in reference to the “ionic liquid” of the MMOD layer and/or radiation shield layer is a salt that exist in liquid state from about −150° C. to about 200° C. Exemplary ionic liquids include imidazolium-based ionic liquids, phosphonium-based ionic liquids, ammonium-based ionic liquids, pyridinium-based ionic liquids, or sulfonium-based ionic liquids. Specific examples of suitable ionic liquids include Trihexyl (Tetradecyl) Phosphonium Bis(trifluoromethylsulfonyl) imide ([P₆₆₆14][NTf2]) and 1-butyl-3-methylimidazolium tetrafluoroborate ([BMIM][BF₄]).

The term “porous architecture” refers to the void formed in the solid layer comprising the volume formed by the combination of the plurality of tubules, plurality of pores, and plurality of interconnecting nodes.

In a first aspect of the present disclosure, a water-transport system is provided. The water-transport system comprises tubules. These tubules comprise a plurality of water channels and may comprise a Fluid-Filled Composite (FFC) system, as that term is understood by a skilled artisan. In embodiments, the tubules mimic a tree xylem structure (i.e., a biomimetic) with multiple networked hydrophilic tubules.

In embodiments, the tubules enable a one-directional fluid flow, or what is known in the art as 1D. In these embodiments, a negative pressure generator may be present at terminal end of the water-transport system in the direction of the fluid flow. Negative pressure generators are known in the field and include, for example, a water pump or any other source of suction. As would be appreciated by those skilled in the art, the present water-transport system operates as a water-storage system when not connected to a negative pressure generator. The negative pressure generator is removably connectable to the water-transport system of the present disclosure. In other embodiments, the negative pressure generator is architectural. For example, the tubules may be an open system whereby evaporation acts as the negative pressure generator to transport water vertically. The fluid within the tubules of the present disclosure may be monitored by one or more sensors. The one or more sensors may be configured to monitor fluid level or volume, temperature, viscosity, electrical conductivity, pressure, and flow rates.

In embodiments, the tubules contain a plurality of pores. In these embodiments, the pore size are about 10 to about 400 microns, preferably with contact angles ranging from 20-60°. The inner surface of the pores may be treated to modify the hydrophilic properties of the surface. For example, the inner surface may be subject to an oxygen plasma etching system. In preferred embodiments, the inner surface of the pore has a mean roughness ranging from about 5 to about 10 microns. Suitable surface treatments maintain space-grade performance standards and structural integrity.

The tubules comprise lightweight polymer material. The lightweight polymer material may be Polyetheretherketone (PEEK), preferably NASA-qualified PEEK. The tubules should be of sufficient size and composition to allow for water cohesion and adhesion, such that water can be transported as intended. In preferred embodiments, the diameter of each tubule should range from about 100 microns to about 150 microns. The location of a tubule relative to other tubules may vary. However, in embodiments, no tubule should be located within 50 microns of another tubule (measuring from the center of each tubule). In other embodiments, no tubule should be located greater than 400 microns from another tubule (measuring from the center of each tubule). In preferred embodiments, each of the plurality of tubules is located 100-300 microns apart from adjacent tubules (measuring from the center of each tubule). The tubules may be dispersed in the solid polymer in a uniform or non-uniform manner.

The water-transport system of the present disclosure may further comprise a plurality of interconnecting nodes to allow adjacent tubules to be in fluid communication with each other. In embodiments, the interconnecting nodes are substantially orthogonal to the cylindrical wall of the connecting tubules. The interconnecting nodes may be located throughout the length of the cylindrical wall. For example, one interconnecting node may be present at least every 25 mm, 20 mm, or 10 mm along the cylindrical wall. In preferred embodiments, one interconnecting node is present at least every 5 mm or 2 mm of the vertical length of the cylindrical wall of the tubule.

Water may occupy up to 90% of the volume of the porous architecture of the water-transport system. Preferably, water occupies about 50% to about 90%, alternatively, about 50% to about 80% of the volume of the porous architecture of the water-transport system.

Advantageously, in embodiments, the water-transport system (including the tubules, pores, and interconnecting nodes) may be 3D printed. In these embodiments, the porous architectures are precisely provided. In some embodiments, the topography of the surface of the pores may be controlled to enhance ionic liquid wetting. Further, the surface of the pores may be further subjected to a post-printing surface treatment, which, preferably will be dependent on the ionic liquid used within the pore architecture.

In a second aspect of the present disclosure, the water-transport system may be integrated into additional structures, such as a shielding or wall. For ease of reference, these additional structures are referred to as a composition. In these embodiments, the width of the water-transport system may be about 8 mm.

The composition comprises a layer comprising or consisting of the water-transport system and at least one other layer. In preferred embodiments, each of the layers of the composition is 3D printed or comprises materials capable of being 3D printed.

One exemplary other layer is a Micrometeoroids and Orbital Debris (MMOD) layer. The width of the MMOD layer may be around 4 mm. In preferred embodiments, the MMOD layer comprises self-healing properties. For example, the layer may be “self-healing” such that upon damage (e.g., space debris impact damage), the layer is comprised of materials that can adhere to one another to maintain structural integrity. The MMOD layer may comprise the composition described in U.S. Pat. No. 7,947,364. Additionally, or alternatively, the MMOD layer may comprise tubules and pores as described herein. The tubule diameter within the MMOD layer may range from about 200 microns to about 300 microns. The pores within the MMOD layer may have a diameter ranging from about 20 microns to about 500 microns, preferably with a pore density ranging from 30-40% by volume. In these embodiments, the tubules of the MMOD layer are designed to contain a liquid, preferably, an ionic liquid. The liquid occupies about 55% to about 75% of the porous architecture of the MMOD layer. Preferably, the ionic liquid has a vapor pressure of less than 10⁻⁷ Pa at 25° C. It has been found that including a tubules in the MMOD layer allow the tubules to deform and dissipate impact energy while the ionic liquid's negligible vapor pressure prevents catastrophic pressure loss that would occur with a volatile fluid. In preferred embodiments, the ionic liquid is capable of solidifying when the integrity of the pore architecture of the MMOD layer is breached. A particularly suitable ionic liquid for the MMOD layer is Trihexyl(tetradecyl)phosphonium bis(trifluoromethylsulfonyl)imide ([P₆₆₆₁₄][NTf₂]). The tubules of the MMOD layer may contain a mixture of ionic liquid and water. Preferably, the mixture of ionic liquid to water comprises a ratio of 10:90 to 30:70.

The tubules of the MMOD layer may further comprise a thermally-responsive polymer additive. Exemplary thermally-responsive polymer additives include poly(N-isopropylacrylamide) (PNIPAM), poly(N-vinylcaprolactam) (PVCL), and Pluronics (Poloxamers).

The tubules of the MMOD layer may further comprise one or more reservoir chambers, where each reservoir chamber may have a diameter around 1 mm.

Another exemplary other layer is a radiation shielding layer, which are known in the art. The width of the radiation shielding layer may be around 3 mm. Preferably, the radiation shielding layer is a hydrogenous material. An exemplary radiation shielding layer is Polyethylene (PE), preferably High-Density PE; Aluminum-Boron alloy; and/or Carbon fiber composites. Additionally, or alternatively, the radiation shielding layer may comprise tubules and pores as described herein, preferably tubules and pores as described with respect to the MMOD layer. The tubules of the radiation shielding layer contain a liquid, preferably an ionic liquid. The liquid occupies about 55% to about 75% of the porous architecture of the radiation shielding layer. In embodiments, the ionic liquid of the radiation shielding layer has a high hydrogen content, such as imidazolium and ammonium-based compounds. The tubules of the radiation shielding layer may include a mixture of ionic liquid and water. For example, the mixture of ionic liquid and water comprises 1-butyl-3-methylimidazolium tetrafluoroborate ([BMIM][BF₄]) and deionized water. In preferred embodiments, the mixture of ionic liquid and water in the tubules of the radiation shielding layer has a ratio of about 70:30 ionic liquid to water. The ionic liquid of the radiation shielding layer may comprise an element with high neutron capture cross-sections, such as boron-containing anions.

Another exemplary other layer is a fire resistance layer, which are known in the art. The width of the fire resistance layer may be around 2 mm. Preferably, the fire resistant layer comprises Polytetrafluoroethylene (PTFE); Beta Cloth (a/k/a silica fiber woven fabric with PTFE coating); and/or Nomex/Kevlar (poly-para-phenylene terephthalamide).

Another exemplary other layer is a vibration dampening layer. Such a layer is configured to reduce acoustic vibrations and are known in the art. An exemplary vibration dampening layer is Fluorosilicone Elastomers, PEEK/Carbon Fiber Composite, and/or Polyimide Foam. In other embodiments, the MMOD layer provides sufficient vibration dampening.

Another exemplary other layer is a structural layer. The structural layer provides the desired geometry and structural integrity for the particular application. The structural layer may be comprised of Aerospace grade aluminum 7075-T6, Carbon fiber reinforced PEEK (e.g., VICTREX PEEK 450CA30), and/or Titanium. The width of the structural layer may be around 5 mm.

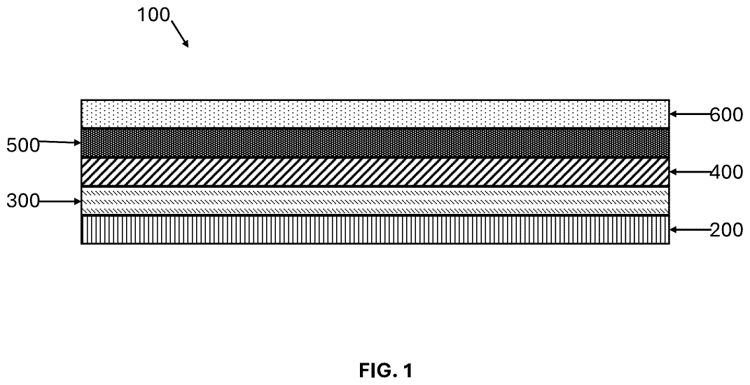

Turning to the figures, FIG. 1 depicts a composition 100 that includes a structural layer 200, a fire resistance layer 300, a water-transport system 400, a radiation shielding layer 500, and a MMOD layer 600. FIG. 1 shows that each layer contacts the immediately adjacent layers. The optional vibration layer is not depicted, but may be disposed between the structural layer 200 and the fire resistance layer 300 or between the fire resistance layer 300 and the layer of the water-transport system 400.

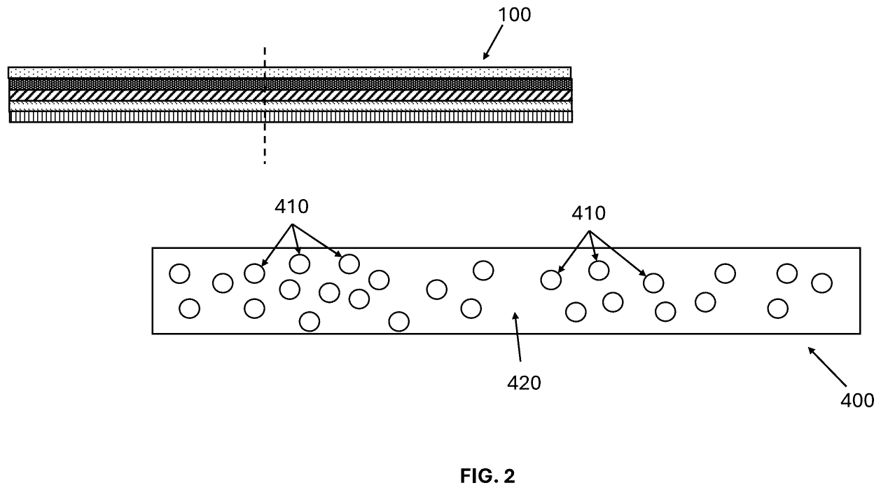

FIG. 2 depicts an exemplary a water-transport system 400 when viewed in a vertical cross-section the composition 100. In this embodiment, the tubules 410 are depicted in the solid polymer layer 420 of the water-transport system 400. FIG. 2 shows an embodiment where the diameter of the tubules 410 have the same or substantially same (±2 mm) diameter as the other pores 410 in a vertical cross section. FIG. 2 also depicts an embodiment where the tubules 410 are not uniformly distributed throughout the layer of the water-transport system 400.

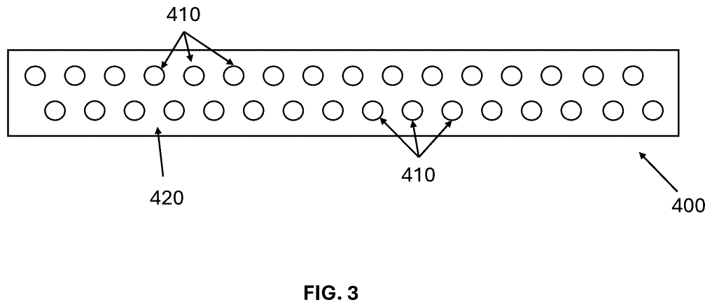

FIG. 3 depicts an alternate embodiment to the water-transport system 400 depicted in FIG. 2. Again, the tubules 410 are depicted in the solid polymer layer 420 of the water-transport system 400. The water-transport system 400 of FIG. 3 includes tubules 410 that have the same or substantially same (±2 mm) diameter as the other tubules 410 in a vertical cross section and the tubules 410 are uniformly distributed throughout the layer of the water-transport system 400.

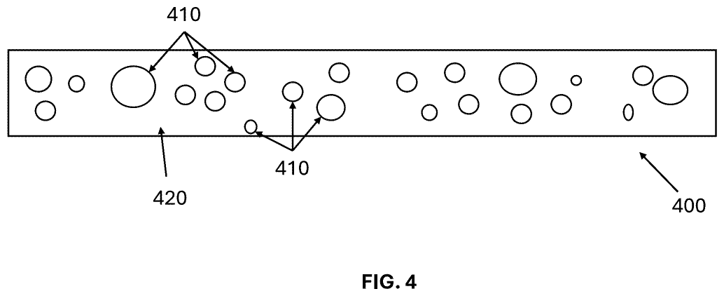

FIG. 4 depicts an alternate embodiment to the water-transport system 400 depicted in FIGS. 2 and 3. Again, the tubules 410 are depicted in the solid polymer layer 420 of the water-transport system 400. The water-transport system 400 of FIG. 4 includes tubules 410 that have varying diameters ranging from about 150 to about 300 microns and are not uniformly dispersed throughout the layer of the water-transport system 400. It is also contemplated that the water-transport system may have tubules 410 of varying diameters and are uniformly dispersed (not shown).

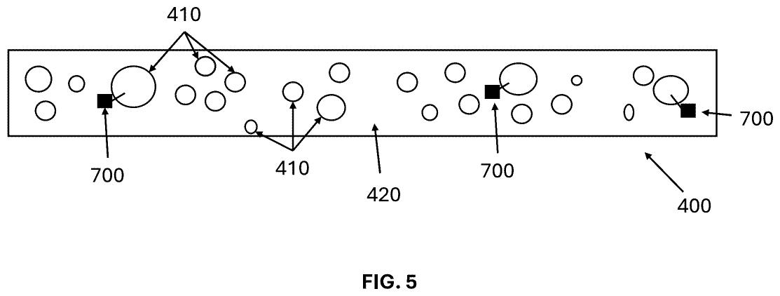

FIG. 5 depicts the embodiment of FIG. 4 and further depicts a plurality of sensors 700 disposed throughout the layer of the water-transport system 400. The sensors 700 may be configured to monitor fluid level or volume, temperature, viscosity, electrical conductivity, pressure, and flow rates in accordance with known methods.

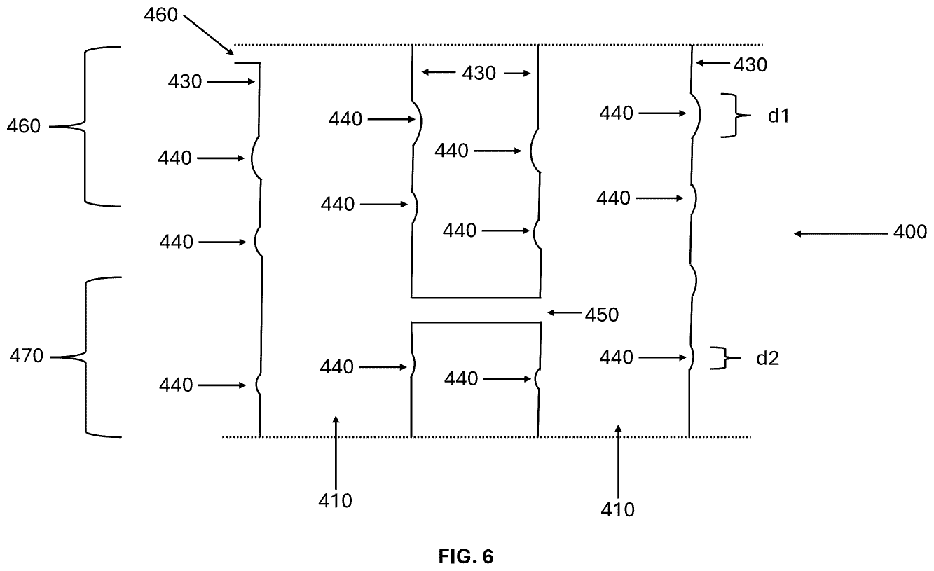

FIG. 6 depicts a cross-section perspective across a vertical plane that intersects the center of two adjacent tubules of in the water-transport system 400. Each tubule 410 contains a cylindrical wall 430 and each wall 430 contains a plurality of pores 440. Each pore 440 has an internal surface that faces the tubule center. This internal surface may be treated to increase wetting. FIG. 6 depicts an embodiment of the present disclosure where the pores located at the upper end of the tubule 460 have a diameter (d1) greater than the diameter of pores located at the bottom end of the tubule 470 (d2). FIG. 6 also depicts an interconnecting node 450 that allows for adjacent tubules to be in fluid communication with each other. A port 460 in the cylindrical wall 430 of the tubule is also depicted that may be in fluid communication with a negative pressure generator or allow for evaporation. FIG. 6 is not drawn to scale and is for illustrative purposes only.

Although FIGS. 2-6 depict the water-transport system 400 of the present disclosure. FIGS. 2-6 also depict embodiments of any tubule-containing layer, such as the MMOD layer 600 and/or the radiation shielding layer 500. To be clear, the water-transport system 400 of the present disclosure always includes tubules to form a porous architecture. The MMOD layer 600 may include tubules to form a porous architecture as depicted in FIGS. 2-6. The radiation shielding layer 500 may include tubules to form a porous architecture as depicted in FIGS. 2-6. While the porous architecture of layers 400, 500 and 600 may be the same or similar, the fluid contained within the porous architecture may vary. For example, the fluid within the porous architecture of layer 400 is water while the porous architecture of layers 500 and/or 600 preferably comprises an ionic liquid.

In a third aspect of the present disclosure, the composition comprising the water-transport system and at least one other layer is an aspect of a vehicle or habitat, particularly a vehicle designed for use or habitats adapted for use in low or zero gravity environments. As would be appreciated by those skilled in the art, the composition may serve as an external surface of the vehicle or habitat and provide protection to the structure while being able to store and transport vital water.

The present inventor surprisingly discovered that the present water-transport system is particularly well-suited for use in low or zero gravity environments, such as space. Traditionally, water-transported into space must be contained in tanks and associated with a mechanical pumping system. Through use of the instant water-transport system, the weight of the tanks and pumping system can be eliminated and water can instead be stored and transported in the fuselage of the spacecraft. The present inventor has calculated that greater than 20% of the mass of traditional systems can be eliminated through the use of the present water-transport system. The water-transport system of the present disclosure could be readily adapted to any vehicle or structure that traditionally contains water tanks.

### Examples

Example 1. Assembly of Water-transport System. A Fused Deposition Modeling (FDM) printer capable of printing PEEK material and equipped with a heated build chamber configured to maintain an ambient temperature ranging from 150 to 180° C. ambient temperature and to reach 250° C. in the heated print bed was used. A NASA-qualified PEEK filament (VICTREX® PEEK 450G; 1.75 mm diameter) was used to print the water-transport system.

Using commercially available CAD Software (SolidWorks), parallel arrays of vertical cylindrical tubules were designed. The tubules were designed to have a diameter of 100-150 microns, to be spaced 100-300 microns apart from adjacent tubules (measuring center to center), and to including horizontal interconnecting nodes every 2 mm along the tubule length to create a networked structure. Circular pores within the tubule walls were also designed where the pores at the bottom of the tubule had a diameter of 10 microns and the pores at the top of the tubule had a diameter of about 400 microns to create a capillary gradient. Pore density was programmed to be 30-40% porosity by volume. The internal surface of the pores was programmed to include 5-10 micron mean roughness to enhance wetting.

The CAD files were exported as STL format with resolution of 0.05 mm. The printer was set with the following parameters: Extruder temperature: 360-380° C. for PEEK; Build chamber temperature: 150-180° C.; Print bed temperature: 250° C.; Layer height: 0.1 mm for fine pore detail; Print speed: 20-30 mm/s for precision; Infill pattern: gyroid; and Infill density: variable density. The water-transport system was printed to a thickness of about 8 mm with a water storage capacity of 20-25 mL for a layer of 8 mm×300 mm. An adhesion promoter (e.g., PEEK binding solution or Kapton tape) was applied to the print bed.

Example 2. Assembly of Shielding Including Water-transport System. The same printer of Example 1 was used to assemble the shielding composition. Using the same CAD software, a five-layer composite structure was designed with the following specifications: Total assembly dimensions: 300 mm×300 mm test panel; Layer 1 (Structural): 5 mm thickness; Layer 2 (Fire Resistance): 2 mm thickness; Layer 3 (Water-Transport System): 8 mm thickness; Layer 4 (Radiation Shielding): 3 mm thickness; Layer 5 (MMOD): 4 mm thickness; and Total assembly thickness: 22 mm.

Each layer of the shielding composition was printed sequentially. To print Layer 1, a STL file was imported into slicing software (e.g. Simplify3D). The infill pattern was set to rectilinear and infill density was set to 100%. Aerospace-grade Aluminum 7075-T6 powder for selective laser melting (1.75 mm) was used as the material for the Layer 1. The layer was monitored and printed over 4-6 hours to achieve a 5 mm thickness. The layer was allowed to slowly cool on the print bed over 1 hour to prevent warping.

Once cooled, Layer 2 was prepared by loading Polytetrafluoroethylene (PFTE) filament into the printer. The STL file for Layer 2 was loaded and the printer was positioned to align printing directly on top of Layer 1 in the slicing software. The extruder temperature was adjusted to 340-360° C. for PFTE. Layer 2 was printed directly on top of Layer 1 over the course of 1.5 to 2 hours. The print bed temperature was maintained at 250° C. to ensure molecular diffusion bonding between Layer 1 and Layer 2 at the interface.

Layer 3 was then printed on top of Layer 2 in accordance with Example 1 (extruder at 370° C., bed at 250° C., chamber at 160° C.) with the printer set at 0.1 mm layer height for accurate pore reproduction. Layer 3 was printed over the course of 8-10 hours due to the complex geometry. The printing process was monitored to ensure pore structures formed correctly and to verify tubule verticality.

Layer 4 was prepared by loading a High-Density Polyethylene (HDPE) filament blended with 15% boron nitride nanoparticles into the printer. A STL file for Layer 4 was loaded. The printer settings were adjusted for the HDPE composite to the following specifications: extruder temperature 220-240° C. and bed temperature 80-100° C. Layer 4 was printed directly onto Layer 3 where the layers bonded through interdiffusion during the cooling of Layer 3 and heating/printing of Layer 4. Layer 4 was printed over the course of 2-3 hours.

Layer 5 was prepared by loading PEEK into the printer and returning the printer to the settings for Layer 3 (extruder 370° C., bed 250° C., chamber 150° C.). A STL file for Layer 5 was loaded. Layer 5 was printed directly on Layer 4 over the course of 4-5 hours. Once Layer 5 was printed a controlled cooling protocol was followed, including reducing chamber temperature by 20° C. per hour until room temperature was reached and reducing bed temperature by 30° C. per hour. The cooling protocol lasted 8-10 hours. Once the composite comprising all five layers was cooled to room temperature, the composite was removed from the printer.

No external adhesives are required as the aforementioned layers are bonded during the 3D printing process. Each layer is advantageously thermally welded to each adjacent layer.

Example 3. Preparation of Ionic Liquid Mixture for MMOD Layer. A mixture of [P₆₆₆₁₄][NTf₂], Poly(N-isopropylacrylamide) (PNIPAM), poly(N-vinylcaprolactam) (PVCL), and Poloxamer 407 (i.e., Pluronic F127) was prepared by heating the mixture to 60° C. and stirring the mixture for 2 hours until a homogenous dispersion was obtained. The final mixture comprised 88% [P₆₆₆₁₄][NTf₂], 4% PNIPAM, 4% PVCL, and 4% Pluronic F127 by total weight.

Example 4. Preparation of Ionic Liquid Mixture for Radiation Shielding Layer. A mixture of [BMIM][BF₄] and deionized water was prepared by mixing at room temperature. The final mixture comprised 70% [BMIM][BF₄] and 30% deionized water by total weight.

Example 5. Assembly of Ionic Liquid Loaded Shielding. A 22-gauge syringe was used to inject the mixture of Example 3 into the MMOD layer (Layer 5) tubules through a top surface opening. Approximately 15-20 mL was injected for the 300 mm×300 mm panel of Example 2 to achieve the desired dispersion throughout the layer. A 22-gauge syringe was used to inject the mixture of Example 4 into the radiation shielding layer (Layer 4) tubules through a top surface opening. Approximately 10-12 mL was injected for the 300 mm×300 mm panel of Example 2 to achieve the desired dispersion throughout the layer.

Example 6. Testing of Water-transport System. The radiation shielding performance of a water-transport system similar to the one described herein was evaluated using SRIM (Stopping and Range of Ions in Matter) software version 2013, a Monte Carlo simulation program based on quantum mechanical treatment of ion-atom collisions. SRIM calculations employ a binary collision approximation to model the stopping power and range of ions in matter through both electronic and nuclear stopping mechanisms.

An experimental sample was constructed using one central layer of polyurethane foam and two outer layers of Kevlar 49 in a sandwich configuration. Each layer of Kevlar 49 had a density of 1.44 g/cm³ and a thickness of 0.18 mm. The polyurethane layer had a dry density of 0.24 g/cm³ and a thickness of 12.7 mm. Deionized water was introduced into the porous polyurethane foam to occupy approximately 50% of the pore volume to achieve an effective density of 0.93 g/cm³. The experimental sample was compared against Aerospace-grade Aluminum 6061-T6 (density=2.70 g/cm³; thickness=18.0 mm for mass equivalence), Tantalum (density: 16.65 g/cm³, thickness: 1.98 cm for equivalent mass), and Lead (density: 11.34 g/cm³, thickness: 0.2916 cm for equivalent mass). Shielding against hydrogen ions, helium ions, Cobalt-60 gamma radiation, and cesium-137, as the most common forms of radiation in space, was assessed.

The SRIM assay was programmed for a monoenergetic, normally incident ion beam with 10,000 ions per energy level. For each ion species, energy was systematically increased in logarithmic increments until complete penetration occurred (>4% of ions transmitted through the material). Stopping Power (MeV·cm²/g) was used as a measurement of shielding potential and the results are shown in Table 1.

TABLE 1
Radiation Shielding Potential

| | Hydrogen | Helium | Co 60 | Cs 137 |
|---|---|---|---|---|
| | (MeV) | (MeV) | (GeV) | (GeV) |
| Lead | 9 | 35 | 2 | 7 |
| Tantalum | 9 | 35 | 2 | 7 |
| FFCM | 28 | 110 | 6.5 | 20 |

As shown in Table 1, the experimental sample surprisingly stopped significantly higher energy particles than that of lead and tantalum at the same weight. These results also show that the water-transport system of the present disclosure would have excellent performance in low earth orbit space. Due to the magnetic fields around Earth, the energy levels in low earth orbit are significantly lower than outside the Van Allen belt. The energy levels have shown to be on average closer to 10 MeV rather than on the scale of 1 GeV.

Given the results in Table 1, substituting the water-transport system of the present disclosure for aluminum would be associated with a mass savings of greater than 20%.

### Embodiments

A. A water-transport system comprising a plurality of vertically-oriented tubules comprising a lightweight polymer with a plurality of vertically-oriented tubules, wherein each tubule comprises a cylindrical wall containing a plurality of pores.
   A1. The water-transport system of embodiment A, wherein each pore has a diameter ranging from about 10 microns to about 400 microns.
      A1a. The water-transport system of embodiment A1, wherein each pore has a diameter ranging from 10 microns to 400 microns.
   A2. The water-transport system of any preceding embodiment, wherein the plurality of pores located at the upper end of the tubule have a greater diameter than pores located at the bottom end of the tubule.
   A3. The water-transport system of any preceding embodiment, wherein the plurality of pores located at the upper end of the tubule have a greater diameter than pores located at the bottom end of the tubule.
   A4. The water-transport system of any preceding embodiment, wherein each pore has an internal surface with modified hydrophilic properties relative to the hydrophilic properties of the internal surface of the cylindrical wall of the tubule.
      A4i. The water-transport system of embodiment A4, wherein the internal surface of the pore has a mean roughness ranging from about 5 to about 10 microns.
      A4ii. The water-transport system of embodiment A4 or A4i, wherein the internal surface is subjected to an oxygen plasma etching system.
   A5. The water-transport system of any preceding embodiment, wherein each pore has a contact angle ranging from of 20° to 60°.
   A6. The water-transport system of any preceding embodiment, wherein the cylindrical wall of the tubule has a diameter ranging from about 100 microns to about 150 microns.
      A6i. The water-transport system of embodiment A6, wherein the cylindrical wall of the tubule has a diameter ranging from 100 microns to 150 microns.
   A7. The water-transport system of any preceding embodiment, wherein each tubule of the plurality of tubules is located greater than 50 microns away from another tubule of the plurality of tubules.
   A8. The water-transport system of any preceding embodiment, wherein each tubule of the plurality of tubules is located no greater than 400 microns away from another tubule of the plurality of tubules.
   A9. The water-transport system of any preceding embodiment, wherein the cylindrical wall further comprises a horizontally-oriented interconnecting node so that at least one of the tubules is in fluid communication with an adjacent tubule.
      A9a. The water-transport system of embodiment A9, wherein the horizontally-oriented interconnecting node comprises an angle formed by the cylindrical wall of the tubule and the wall of the node less than 45 degrees.
      A9b. The water-transport system of embodiment A9, wherein the horizontally-oriented interconnecting node comprises a wall of the node orthogonal to the cylindrical wall of the tubule.
      A9c. The water-transport system of any one embodiment A9 to A9b, wherein a plurality of interconnecting nodes are dispersed along the length of the cylindrical wall of the tubule.
      A9d. The water-transport system of embodiment A9c, wherein one interconnecting node is located within each 25 mm of the vertical length of the cylindrical wall of the tubule.
      A9e. The water-transport system of embodiment A9c, wherein one interconnecting node is located within each 20 mm of the vertical length of the cylindrical wall of the tubule.
      A9f. The water-transport system of embodiment A9c, wherein one interconnecting node is located within each 10 mm of the vertical length of the cylindrical wall of the tubule.
      A9g. The water-transport system of embodiment A9c, wherein one interconnecting node is located within each 5 mm of the vertical length of the cylindrical wall of the tubule.
      A9h. The water-transport system of embodiment A9c, wherein one interconnecting node is located within each 2 mm of the vertical length of the cylindrical wall of the tubule.
   A10. The water-transport system of any preceding embodiment, wherein the lightweight polymer comprises polyetheretherketone (PEEK), preferably NASA-qualified PEEK.
   A11. The water-transport system of any preceding embodiment, further comprising water within the cylindrical wall of the plurality of vertically-oriented tubules.
   A12. The water-transport system of any preceding embodiment, wherein the system is a Fluid-Filled Composite (FFC) system.
   A13. The water-transport system of any preceding embodiment, wherein the plurality of tubules are configured to enable a one-directional fluid flow.
   A14. The water-transport system of any preceding embodiment, further comprising a negative pressure generator.
      A14i. The water-transport system of embodiment A14, wherein the negative pressure generator is a water pump.
   A15. The water-transport system of any preceding embodiment, further comprising a port configured to allow for evaporation of water within the water-transport system.
   A16. The water-transport system of any preceding embodiment, wherein the system is 3D printed.
   A17. The water-transport system of any preceding embodiment, wherein the pore density is 30-40% by volume.
   A18. The water-transport system of any preceding embodiment, further comprising water.
      A18a. The water-transport system of embodiment A18, wherein the water occupies up to 90% of the porous architecture of the water-transport system.
      A18b. The water-transport system of embodiment A18 or A18a, wherein the water occupies about 50% to about 90% of the porous architecture of the water-transport system.
         A18b(i). The water-transport system of embodiment A18b, wherein the water occupies 50% to 90% of the porous architecture of the water-transport system.
      A18c. The water-transport system of embodiment A18 or A18a, wherein the water occupies about 50% to about 80% of the porous architecture of the water-transport system.
         A18c(i). The water-transport system of embodiment A18c, wherein the water occupies 50% to 80% of the porous architecture of the water-transport system.
B. A composition comprising
   a layer comprising the water-transport system of any preceding embodiment; and at least one additional layer.
   B1. The composition of embodiment B, wherein the at least one additional layer is a Micrometeoroids and Orbital Debris (MMOD) layer.
      B1a. The composition of embodiment B1, wherein the MMOD layer has a width of about 4 mm or 4 mm.
      B1b. The composition of embodiment B1 or B1a, wherein the MMOD layer is self-healing.
      B1c. The composition of any one embodiment from B1 to B1b, wherein the MMOD layer comprises a plurality of tubules and a plurality of pores.
         B1c(i). The composition of embodiment B1c, wherein the diameter of each tubule ranges from about 20 microns to about 500 microns or 20 microns to 500 microns.
         Bc(ii). The composition of embodiment B1, B1c, or B1c(i), wherein each tubule has a pore density ranging from 30-40% by volume.
      B1d. The composition of any preceding embodiment of B1 (i.e., B1, B1a, B1b, B1c, B1c(i), or B1c(ii)), wherein the MMOD layer further comprises a liquid.
         B1d(i). The composition of embodiment B1d, wherein the liquid comprises an ionic liquid.
         B1d(ii). The composition of embodiment B1d(i), wherein the ionic liquid has a vapor pressure of less than 10⁷ Pa at 25° C.
         B1d(iii). The composition of embodiment B1d(i) or B1d(ii), wherein the ionic liquid comprises or consists of Trihexyl(tetradecyl)phosphonium bis(trifluoromethylsulfonyl)imide ([P₆₆₆₁₄][NTf₂]).
         B1d(iv). The composition of embodiment B1d, wherein the liquid is a mixture of ionic liquid and water.
         B1d(v). The composition of embodiment B1d(iv), wherein the ratio of ionic liquid to water is 10:90 to 30:70.
         B1d(vi). The composition of embodiment B1d, wherein the liquid occupies about 55% to about 75%, or 55% to 75%, of the porous architecture of the MMOD layer.
      B1e. The composition of any preceding embodiment of B1, wherein the MMOD layer further comprises one or more thermally-responsive polymer additives.
         B1e(i). The composition of embodiment B1e, wherein the thermally-responsive polymer additive is selected from the group consisting of a poly(N-isopropylacrylamide) (PNIPAM), a poly(N-vinylcaprolactam) (PVCL), and a poloxamer; or a mixture thereof.
      B1f. The composition of any preceding embodiment of B1, wherein the MMOD layer further comprises a reservoir chamber.
         B1f(i). The composition of embodiment B1f, wherein the reservoir chamber has a diameter of about 1 mm or 1 mm.
   B2. The composition of any preceding embodiment of B (i.e., B, B1, B1a, B1b, B1c . . . ), wherein the at least one additional layer is a radiation shielding layer.
      B2a. The composition of embodiment B2, wherein the radiation shielding layer has a width of about 3 mm or 3 mm.
      B2b. The composition of embodiment B2 or B2a, wherein the radiation shielding layer comprises a hydrogenous material.
      B2c. The composition of any preceding embodiment of B2, wherein the radiation shielding layer is composed of one or materials selected from the group consisting of polyetheylene, an aluminum-boron alloy, and a carbon fiber composite; or a mixture thereof.
         B2c(i). The composition of embodiment B2c, wherein the polyethylene is high-density polyethylene.
      B2d. The composition of any preceding embodiment of B2, wherein the radiation shielding layer comprises a plurality of tubules and a plurality of pores.
         B2d(i). The composition of embodiment B2d, wherein each pore has a diameter ranging from about 10 microns to about 400 microns or about 20 microns to about 500 microns.
         B2d(ii). The composition of embodiment B2d(i), wherein each pore has a diameter ranging from 10 microns to 400 microns or 20 microns to 500 microns.
         B2d(iii). The composition of any preceding embodiment of B2d, wherein the plurality of pores located at the upper end of the tubule have a greater diameter than pores located at the bottom end of the tubule.
         B2d(iv). The composition of any preceding embodiment of B2d, wherein the plurality of pores located at the upper end of the tubule have a greater diameter than pores located at the bottom end of the tubule.
         B2d(v). The composition of any preceding embodiment of B2d, wherein each pore has an internal surface with modified hydrophilic properties relative to the hydrophilic properties of the internal surface of the cylindrical wall of the tubule.
         B2d(vi). The composition of embodiment of B2d, wherein the internal surface of the pore has a mean roughness ranging from about 5 to about 10 microns.
         B2d(vii). The composition of embodiment of B2d(v) or of B2d(vi), wherein the internal surface is subjected to an oxygen plasma etching system.
         B2d(viii). The composition of any preceding embodiment of B2d, wherein each pore has a contact angle ranging from of 20° to 60°.
         B2d(ix). The composition of any preceding embodiment of B2d, wherein the cylindrical wall of the tubule has a diameter ranging from about 100 microns to about 150 microns.
         Bd2(x). The composition of embodiment B2d(ix), wherein the cylindrical wall of the tubule has a diameter ranging from 100 microns to 150 microns.
         B2d(xi). The composition of any preceding embodiment of B2d, wherein each tubule of the plurality of tubules is located greater than 50 microns away from another tubule of the plurality of tubules.
         B2d(xii). The composition of any preceding embodiment of B2d, wherein each tubule of the plurality of tubules is located no greater than 400 microns away from another tubule of the plurality of tubules.
         B2d(xiii). The composition of any preceding embodiment of B2d, wherein the cylindrical wall further comprises a horizontally-oriented interconnecting node so that at least one of the tubules is in fluid communication with an adjacent tubule.
         B2d(xiv). The composition of embodiment of B2d, wherein the horizontally-oriented interconnecting node comprises an angle formed by the cylindrical wall of the tubule and the wall of the node less than 45 degrees.
         B2d(xv). The composition of embodiment of B2d, wherein the horizontally-oriented interconnecting node comprises a wall of the node orthogonal to the cylindrical wall of the tubule.
         B2d(xvi). The composition of any preceding embodiment of B2d, wherein a plurality of interconnecting nodes are dispersed along the length of the cylindrical wall of the tubule.
         B2d(xvii). The composition of any preceding embodiment of B2d, wherein each tubule has a pore density ranging from 30-40% by volume.
      B2e. The composition of any preceding embodiment of B2, wherein the radiation shielding layer further comprises a liquid.
         B2e(i). The composition of embodiment B2e, wherein the liquid comprises an ionic liquid.
         B2e(ii). The composition of embodiment B2e(i), wherein the ionic liquid has a high hydrogen content.
         B2e(iii). The composition of embodiment B2e(i) or B2e(ii), wherein the ionic liquid comprises imidazolium or an ammonium-based compound.
         B2e(iv). The composition of embodiment B2e(i), wherein the ionic liquid comprises an element with high neutron capture cross-sections, preferably boron-containing anions.
         B2e(v). The composition of embodiment B2e(i), B2e(ii), or B2e(iii), wherein the ionic liquid comprises or consists of 1-butyl-3-methylimidazolium tetrafluoroborate ([BMIM][BF₄]).
         B2e(vi). The composition of embodiment B2e, wherein the liquid is a mixture of an ionic liquid and water.
         B2e(vii). The composition of embodiment B2e(vi), wherein the ratio of ionic liquid to water is about 70:30 or 70:30.
         B2e(viii). The composition of any one embodiment of B2e (i.e., B2e to B2e(vii)), wherein the liquid occupies about 55% to about 75%, or 55% to 75%, of the porous architecture of the radiation shielding layer.
   B3. The composition of any preceding embodiment of B, wherein the at least one additional layer is a fire resistance layer.
      B3a. The composition of embodiment B3, wherein the width of the fire resistance layer is about 2 mm or 2 mm.
      B3b. The composition of embodiment B3 or B3a, wherein the fire resistance layer is composed of a material selected from the group consisting of polytetrafluoroethylene (PTFE), silica fiber woven fabric with PTFE coating, and poly-para-phenylene terephthalamide; or a mixture thereof.
   B4. The composition of any preceding embodiment of B, wherein the at least one additional layer is a vibration dampening layer.
      B4a. The composition of embodiment B4, wherein the vibration dampening layer is composed of a material selected from the group consisting of a fluorosilicone elastomer, PEEK/Carbon Fiber Composite, and Polyimide Foam; or a mixture thereof.
   B5. The composition of any preceding embodiment of B, wherein the at least one additional layer is a structural layer.
      B5a. The composition of embodiment B5, wherein the width of the structural layer is about 5 mm or 5 mm.
      B5b. The composition of embodiment B5 or B5a, wherein the structural layer is composed of material selected from the group consisting of Aerospace grade aluminum 7075-T6, Carbon fiber reinforced PEEK, and Titanium; or a mixture thereof.
C. A composition comprising:
   a layer comprising the water-transport system of any one embodiment from
   A to A18c(i);
   a structural layer;
   a fire resistance layer,
   a radiation shielding layer, and
   a Micrometeoroids and Orbital Debris (MMOD) layer.
   C1. The composition of embodiment C, wherein the structural layer is defined by any one of the embodiments B5a or B5b.
   C2. The composition of embodiment C or C1, wherein the fire resistant layer is defined by any one of embodiments B3a or B3b.
   C3. The composition of embodiment C, C1, or C2, wherein the radiation shielding layer is defined by any one of embodiments B2a to B2e(vii).
   C4. The composition of embodiment C, C1, C2, or C3, wherein the MMOD layer is defined by any one of embodiments from B1a to B1f(i).
   C5. The composition of any preceding embodiment of C, further comprising a vibration dampening layer.
   C6. The composition of any preceding embodiment of C, wherein the fire resistance layer is disposed in between the structural layer and the layer comprising the water-transport system, and the radiation shielding layer is disposed in between the MMOD layer and the layer comprising the water-transport system.
D. A method of making the composition of any preceding composition of B or C, comprising
   with a 3D printer, printing the structural layer; allowing the structural layer to cool; on the structural layer, printing the fire resistance layer; on the fire resistance layer, printing the layer comprising a water-transport system; on the layer comprising a water-transport system, printing the radiation shielding layer; on the radiation shielding layer, printing the MMOD layer; and obtaining the composition.
   D1. The method of embodiment D, wherein the structural layer is defined by any one of the embodiments B5a or B5b.
   D2. The method of embodiment D or D1, wherein the fire resistant layer is defined by any one of embodiments B3a or B3b.
      D2a. The method of embodiment D2, wherein the printing of the fire resistant layer comprises setting the extruder temperature to 340-360° C.
      D2b. The method of embodiment D2 or D2a, wherein the printing of the fire resistant layer comprises setting the print bed temperature to 250° C.
   D3. The method of embodiment D, D1, or D2, wherein the radiation shielding layer is defined by any one of embodiments B2a to B2e(vii).
      D3a. The method of embodiment D3, wherein the printing of the radiation shielding layer comprises setting the extruder temperature to 220-240° C.
      D3b. The method of embodiment D3 or D3a, wherein the printing of the radiation shielding layer comprises setting the print bed temperature is set to 80-100° C.
   D4. The method of embodiment D, D1, D2, or D3, wherein the MMOD layer is defined by any one of embodiments from B1a to B1f(i).
      D4a. The method of embodiment D4, wherein the printing of the MMOD layer comprises setting the extruder temperature to 340-360° C.
      D4b. The method of embodiment D4 or D4a, wherein the printing of the MMOD layer comprises setting the print bed temperature to 250° C.
   D5. The method of embodiment D, D1, D2, D3, or D4, wherein the water-transport system is defined by any one of embodiments A to A17.
      D5a. The method of embodiment D5, wherein the printing of the water-transport system comprises setting the extruder temperature to 360-380° C.
      D5b. The method of embodiment D5 or D5a, wherein the printing of the water-transport system comprises setting the build chamber temperature to 150-180° C.
      D5c. The method of embodiment D5, D5a, or D5b, wherein the printing of the water-transport system comprises setting the print bed temperature to 250° C.
      D5d. The method of embodiment D5, D5a, D5b, or D5c, wherein the printing of the water-transport system comprises setting the layer height to 0.1 mm.
   D6. The method of any preceding embodiment of D, wherein the composition comprises an ordered layering of structural layer, fire resistance layer, water-transport layer, radiation shielding layer, and MMOD layer.
   D7. The method of any preceding embodiment of D, wherein each layer is printed sequentially.
   D8. The method of any preceding embodiment of D, wherein no adhesive is applied to adhere to or bond the layers.
   D9. The method of any preceding embodiment of D, wherein the allowing the structural layer to cool step comprising allowing the structural layer to cool at least one hour.
   D10. The method of any preceding embodiment of D, wherein the fire resistance layer is disposed in between the structural layer and the layer comprising the water-transport system, and the radiation shielding layer is disposed in between the MMOD layer and the layer comprising the water-transport system.

1. A water-transport system comprising: a plurality of vertically-oriented tubules comprising a lightweight polymer with a plurality of vertically-oriented tubules, wherein each tubule comprises a cylindrical wall containing a plurality of pores.

2. The water-transport system of claim 1, wherein each pore has a diameter ranging from about 10 microns to about 400 microns.

3. The water-transport system of claim 2, wherein the plurality of pores located at the upper end of the tubule have a greater diameter than pores located at the bottom end of the tubule.

4. The water-transport system of claim 2, wherein each pore has an internal surface with a mean roughness ranging from about 5 to about 10 microns.

5. The water-transport system of claim 4, wherein each pore has a contact angle ranging from of 20° to 60°.

6. The water-transport system of claim 1, wherein the cylindrical wall of the tubule has a diameter ranging from about 100 microns to about 150 microns.

7. The water-transport system of claim 6, wherein each tubule of the plurality of tubules is located greater than 50 microns away from another tubule of the plurality of tubules.

8. The water-transport system of claim 7, wherein each tubule of the plurality of tubules is located no greater than 400 microns away from another tubule of the plurality of tubules.

9. The water-transport system of claim 1, wherein the cylindrical wall further comprises a horizontally-oriented interconnecting node so that at least one of the tubules is in fluid communication with an adjacent tubule.

10. The water-transport system of claim 1, wherein the lightweight polymer comprises polyetheretherketone.

11. The water-transport system of claim 1, further comprising water within the cylindrical wall of the plurality of vertically-oriented tubules.

12. A composition comprising:
a layer comprising the water-transport system of claim 1;
a structural layer;
a fire resistance layer;
a radiation shielding layer; and
a Micrometeoroids and Orbital Debris (MMOD) layer.

13. The composition of claim 12, wherein each layer is 3D printed.

14. The composition of claim 13, wherein the fire resistance layer is disposed in between the structural layer and the layer comprising the water-transport system, and the radiation shielding layer is disposed in between the MMOD layer and the layer comprising the water-transport system.

15. The composition of claim 13, wherein the layer comprising the water-transport system comprises NASA-qualified polyetheretherketone; the structural layer comprises Aerospace grade aluminum 7075-T6, Carbon fiber reinforced PEEK, or titanium; the fire resistance layer comprises poly-para-phenylene polytetrafluoroethylene, silica fiber woven fabric with PTFE coating, or terephthalamide; the radiation shielding layer comprises polyethylene; and the MMOD layer comprises polyetheretherketone.

16. The composition of claim 15, wherein radiation shielding layer further comprises an ionic liquid.

17. The composition of claim 16, wherein the ionic liquid comprises a mixture of 1-butyl-3-methylimidazolium tetrafluoroborate and water.

18. The composition of claim 15, wherein the MMOD layer further comprises an ionic liquid.

19. The composition of claim 18, wherein the ionic liquid comprises Trihexyl(tetradecyl)phosphonium bis(trifluoromethylsulfonyl)imide.

20. A method of making the composition of claim 12, comprising:
printing the structural layer;
allowing the structural layer to cool;
on the structural layer, printing the fire resistance layer;
on the fire resistance layer, printing the layer comprising a water-transport system;
on the layer comprising a water-transport system, printing the radiation shielding layer;
on the radiation shielding layer, printing the MMOD layer; and
obtaining the composition of claim 12.
